(19) United States
(12) Patent Application Publication
(10) Pub. No.: US 2024/0413592 A1
(43) Pub. Date: Dec. 12, 2024

(54) CONNECTION MECHANISM HAVING SHIELD, ELECTRIC ENERGY TRANSMISSION APPARATUS, AND MOTOR VEHICLE

(71) Applicant: Changchun Jetty Automotive Technology Co., Ltd., Jilin (CN)

(72) Inventors: Chao WANG, Jilin (CN); Chuan LIU, Jilin (CN)

(21) Appl. No.: 18/695,783

(22) PCT Filed: Sep. 30, 2022
(86) PCT No.: PCT/CN2022/123138

§ 371 Date: Mar. 26, 2024

(30) Foreign Application Priority Data
Oct. 1, 2021 (CN) 202111167054.3
Oct. 1, 2021 (CN) 202122400684.2

(51) Int. Cl. H01R 13/6597; H01R 13/6592

(52) U.S. Cl. CPC H01R 13/6597; H01R 13/6592; H01R 2201/26

(57) ABSTRACT

The present disclosure provides a connection mechanism having a shield, an electric energy transmission apparatus and a motor vehicle, in which the connection mechanism includes a functional cable, a plug-in terminal, a protective conductor, a grounding terminal, an inner shell integrally formed with the functional cable and the plug-in terminal, and a protective shielding shell disposed on at least part of an outer periphery of the inner shell; the functional cable is provided having a shielding layer, one end of the protective shielding shell is at least partially electrically connected to the shielding layer, and the other end thereof is at least partially electrically connected to the protective conductor or the grounding terminal; the connection mechanism having a shield is provided with the inner shell which is integrally injection-molded with the functional cable and the plug-in terminal.

### CROSS REFERENCE TO RELATED APPLICATIONS

This application is a National Phase Entry of International Application No. PCT/CN2022/123138, filed Sep. 30, 2022, and claims priority to Chinese Patent Application No. 202111167054.3, filed Oct. 1, 2021, and to Chinese Patent Application No. 202122400684.2, filed Oct. 1, 2021, all of which are incorporated herein by reference in their entireties.

### TECHNICAL FIELD

The present disclosure relates to the field of electrical connections, and particularly to a connection mechanism having a shield, an electric energy transmission apparatus and a motor vehicle.

### BACKGROUND

The new energy battery of a new energy automobile uses a charging system for energy supplementation. In the charging system, besides a charging socket, there is a high-voltage connection mechanism connected to a battery system. A charging harness is the most important unit in a high-voltage system of the electric automobile. The traditional charging harness uses a copper wire as a charging cable, and an end of the copper wire is connected to a plug-in terminal, which is electrically connected to the battery system. At present, the high-voltage connection mechanisms are all assembled structures, which have the problems of complicated structures, difficult assembling and high costs. In addition, the high usage amount of copper and the complicated connection processing for the cables and terminals are also the reasons for the high cost of the high-voltage connection mechanisms.

In addition, in the charging system, a temperature measuring structure is generally mounted on the charging socket rather than the charging harness connection mechanism, but current is also conducted, and when the temperature of the charging harness connection mechanism rises, it is necessary to monitor and stop the charging operation in time to ensure the safety of the charging harness and the battery system.

Furthermore, in order to reduce the influence of electromagnetic interference, the high-voltage connection mechanism usually needs to shield PE wires. At present, the connection mechanism is generally not provided with a shielding device for shielding, which leads to a great electromagnetic interference from the PE wires at the position of the connection mechanism. A metal cover is disposed inside or outside the connection mechanism to achieve a shielding effect. However, the metal cover is difficult to be processed and the cost is high, and the assembly of the metal cover and the connection mechanism is also troublesome, which increases the assembly time. Moreover, when the metal cover is inside the connection mechanism, a short-circuit with a conductive core will easily occur, which leads to the damage of the shielding layer and even the burning of the cable, resulting in serious accidents.

With the market expansion of the electric automobiles, the charging system is in urgent need of a high-voltage connection mechanism with a simple structure, a cost advantage and a PE wire shielding effect, and an electric energy transmission apparatus.

### SUMMARY

The present disclosure aims to provide a connection mechanism having a shield, which is provided with an inner shell integrally injection-molded with a functional cable and a plug-in terminal, so that the processing is simple, and the cost is much lower than that of a shielding metal shell. Through a plug-in cooperation between the connection mechanism having a shield and a mating connection mechanism, as well as the electrical connection with a shielding net of the functional cable and a shielding layer, it is possible to effectively shield electromagnetic interference in the connection mechanism, and reduce the electromagnetic interference on other devices.

The above objective of the present disclosure can be achieved by adopting the following technical solutions.

The present disclosure provides a connection mechanism having a shield, including a functional cable, a plug-in terminal, an inner shell integrally formed with the functional cable and the plug-in terminal, and a protective shielding shell disposed on at least part of an outer periphery of the inner shell; the functional cable is provided with a shielding layer, to which the protective shielding shell is at least partially electrically connected.

In an exemplary embodiment, the connection mechanism further includes a protective conductor and a grounding terminal, one end of the protective shielding shell is at least partially electrically connected to the shielding layer, and the other end thereof is at least partially electrically connected to the protective conductor or the grounding terminal.

In an exemplary embodiment, the protective shielding shell includes a shielding device which is at least partially electrically connected to the shielding layer.

In an exemplary embodiment, an inner surface of the protective shielding shell is further provided with an electrically-conductive elastic sheet, which is in contacted connection with the shielding layer and applies a pressure thereto.

In an exemplary embodiment, the pressure applied by the electrically-conductive elastic sheet is in a range of 0.3 N to 95 N.

In an exemplary embodiment, an impedance between the protective shielding shell and the shielding layer is less than 80 mΩ.

In an exemplary embodiment, a transfer impedance of the protective shielding shell is less than 100 mΩ.

In an exemplary embodiment, the protective shielding shell and at least part of the shielding layer are integrally injection-molded.

In an exemplary embodiment, the plug-in terminal includes a first fixation portion and a plug-in portion which are sequentially disposed.

In an exemplary embodiment, the functional cable includes a cable core disposed at an innermost part, a shielding layer sleeved around an outer periphery of the cable core, and an insulation layer sleeved around an outer periphery of the shielding layer, and the first fixation portion is electrically connected to a conductive part of the cable core.

In an exemplary embodiment, the plug-in portion is columnar and at least partially protrudes from the inner shell, or the inner shell has a groove, and the plug-in portion at least partially protrudes from a bottom surface of the groove without exceeding the inner shell.

In an exemplary embodiment, the plug-in portion is barrel-shaped and at least partially protrudes from an outer wall of the inner shell, or the inner shell is provided with an open boss in which the plug-in portion is at least partially disposed.

In an exemplary embodiment, the protective shielding shell at least wraps the first fixation portion and at least part of the functional cable, but is insulated from the plug-in terminal and a conductive part of the functional cable.

In an exemplary embodiment, the inner shell is integrally injection-molded on outer peripheries of at least the first fixation portion, the plug-in terminal and a conductive part of the functional cable, and achieves an insulation effect.

In an exemplary embodiment, the protective shielding shell at least wraps the outer periphery of the inner shell, and the protective shielding shell is integrally injection-molded on at least part of the outer periphery of the inner shell.

In an exemplary embodiment, the outer periphery of the inner shell and/or the protective shielding shell is further integrally injection-molded with an outer insulation shell, which wraps at least part of the inner shell and/or the protective shielding shell and at least part of the functional cable.

In an exemplary embodiment, the connection mechanism comprises an interlocking connection mechanism at least partially integrally injection-molded in the inner shell.

In an exemplary embodiment, the grounding terminal comprises a second fixation portion and a plug-in portion, and the second fixation portion is electrically connected to the protective conductor.

In an exemplary embodiment, the plug-in portion is columnar and at least partially protrudes from the inner shell, or the inner shell has a groove, and the plug-in portion at least partially protrudes from a bottom surface of the groove without exceeding the inner shell.

In an exemplary embodiment, the plug-in portion is barrel-shaped and at least partially protrudes from an outer wall of the inner shell, or the inner shell is provided with an open boss in which the plug-in portion is at least partially disposed.

In an exemplary embodiment, the inner shell is integrally injection-molded on outer peripheries of at least the second fixation portion and a conductive part of the protective conductor, and achieves an insulation effect.

In an exemplary embodiment, the protective shielding shell at least wraps an outer periphery of the second fixation portion and/or a conductive part of the protective conductor, and the protective shielding shell is electrically connected to the second fixation portion and/or the conductive part of the protective conductor.

In an exemplary embodiment, the connection mechanism comprises a seal structure.

In an exemplary embodiment, an outer periphery of the inner shell and/or the protective shielding shell comprises an outer insulation shell, and the seal structure is secondarily injection-molded on the inner shell and/or the protective shielding shell, and/or the seal structure is secondarily injection-molded on the outer insulation shell.

In an exemplary embodiment, the connection mechanism comprises at least one temperature measuring structure configured to measure a temperature of the plug-in terminal and/or the grounding terminal.

In an exemplary embodiment, the connection mechanism comprises at least one temperature measuring structure attached to the plug-in terminal and/or the grounding terminal and configured to measure a temperature thereof.

In an exemplary embodiment, a weight of the connection mechanism is less than or equal to 272 g.

In an exemplary embodiment, a height of the connection mechanism along a insertion direction is less than or equal to 274 mm.

In an exemplary embodiment, at least part of a surface of the plug-in terminal and/or the grounding terminal is provided with a conductive anticorrosion layer.

In an exemplary embodiment, a conductive part of the protective conductor is integrally formed with the grounding terminal.

In an exemplary embodiment, a conductive part of the functional cable is integrally formed with the plug-in terminal.

The present disclosure provides an electric energy transmission apparatus, including the aforementioned connection mechanism having a shield.

The present disclosure provides a motor vehicle, including the aforementioned connection mechanism having a shield.

The present disclosure has the following characteristics and advantages:

1. The connection mechanism having a shield in the present disclosure is provided with an inner shell which is integrally injection-molded with the functional cable and the plug-in terminal, so that the processing is simple, and the cost is much lower than that of a shielding metal shell. Through a plug-in cooperation between the connection mechanism having a shield and a mating connection mechanism, as well as the electrical connection with the shielding net of the functional cable and the protective conductor, it is possible to effectively shield the electromagnetic interference in the connection mechanism, and reduce the electromagnetic interference on other devices.

2. The protective shielding shell in the present disclosure is connected to the shielding net of the functional cable in various ways, so that the protective shielding shell can be stably and effectively connected to the shielding net, thereby achieving a better shielding effect.

3. The protective shielding shell in the present disclosure is electrically connected to not only the shielding net of the functional cable, but also the protective conductor or the grounding terminal to ensure double grounding. Even if the shielding net of the functional cable fails to be grounded, it may be grounded through the protective conductor, so that the shielding current can be smoothly led out and the interference of the electromagnetic shielding can be reduced.

4. The embedded high-voltage interlocking structure replaces the traditional assembled high-voltage interlocking structure, and is fixed in the connection mechanism by integral injection-molding without assembling, so that the cost is reduced and the high-voltage interlocking effect is completely satisfied.

5. The seal structure of the connection mechanism is no longer a separate seal ring, but adopts a secondarily injection-molded seal structure to replace the traditional seal ring, so as to be directly molded on the connection mechanism, thereby achieving a better injection bonding and a lower cost.

6. By adopting the temperature measuring structure, it is possible to separately monitor the terminal temperature inside the connection mechanism, and avoid the situation that the temperature of the connection mechanism cannot be monitored due to the damage of the temperature sensors in other positions.

### BRIEF DESCRIPTION OF THE DRAWINGS

In order to more clearly explain the technical solutions in the embodiments of the present disclosure, the drawings to be used in the description of the embodiments will be briefly introduced as follows. Obviously, the drawings used in the following description only illustrate some embodiments of the present disclosure, and those of ordinary skill in the art can obtain other drawings from them without paying any creative labor.

FIG. 1 illustrates a structural diagram of a connection mechanism having a shield in the present disclosure.

FIG. 2 illustrates a structural diagram of an inner shell in the present disclosure.

FIG. 3 illustrates a structural diagram of a protective shielding shell in the present disclosure.

FIG. 4 illustrates a structural diagram of an insulation shell in the present disclosure.

FIG. 5 illustrates a schematic diagram of columnar structures of a plug-in terminal and a grounding terminal in the present disclosure.

FIG. 6 illustrates a schematic diagram of barrel-shaped structures of a plug-in terminal and a grounding terminal in the present disclosure.

FIG. 7 illustrates a cross-sectional view of a connection mechanism having a shield in the present disclosure.

FIG. 8 illustrates another cross-sectional view of a connection mechanism having a shield in the present disclosure.

FIG. 9 illustrates another cross-sectional view of a connection mechanism having a shield in the present disclosure.

In which,

10: functional cable; 11: plug-in terminal; 12: shielding layer; 111: first fixation portion; 112: plug-in portion;

101: wire core; 102: insulation layer; 13: interlocking connection mechanism;

20: protective conductor; 21: grounding terminal; 211: second fixation portion; 212: plug-in portion;

30: inner shell;

40: protective shielding shell; 41: shielding device; 42: electrically-conductive elastic sheet;

50: outer insulation shell;

60: seal structure.

### DETAILED OF THE EMBODIMENTS

The technical solutions in the embodiments of the present disclosure will be clearly and completely described below with reference to the drawings for the embodiments of the present disclosure. Obviously, those described are merely a part, rather than all, of the embodiments of the present disclosure. Based on the embodiments of the present disclosure, any other embodiment obtained by those of ordinary skill in the art without paying any creative labor should fall within the protection scope of the present disclosure.

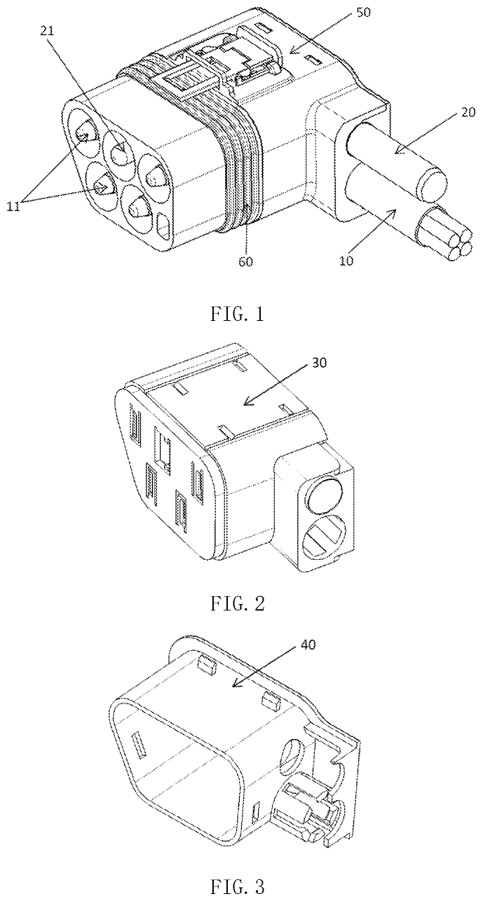

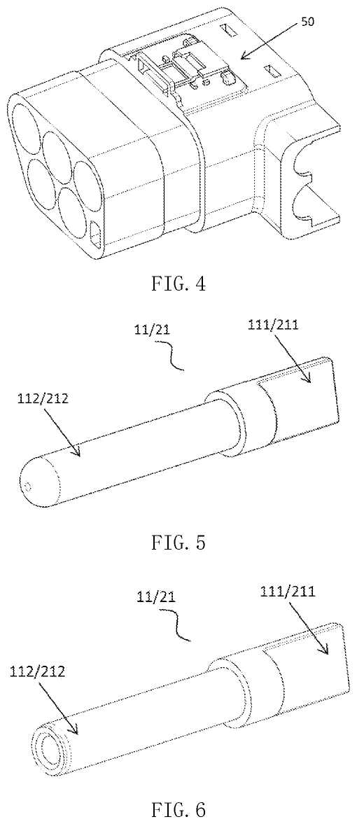

As illustrated in FIGS. 1 to 4, a connection mechanism having a shield includes a functional cable 10, a plug-in terminal 11, an inner shell 30 integrally formed with the functional cable 10 and the plug-in terminal 11, and a protective shielding shell 40 disposed on at least part of an outer periphery of the inner shell 30; the functional cable 10 is provided with a shielding layer 12, to which the protective shielding shell 40 is at least partially electrically connected.

In the connection mechanism having a shield, since large current is to be transmitted by the functional cable 10, a large electromagnetic field will be generated around the functional cable 10 when the current passes. In order to prevent the electromagnetic field generated by the large current from electromagnetically interfering with the electrical appliances in the ambient environment and affecting the normal work of other electrical appliances, the shielding layer 12 is disposed outside a conductive core of the functional cable 10 to electromagnetically shield the electromagnetic field generated after the functional cable 10 is electrified.

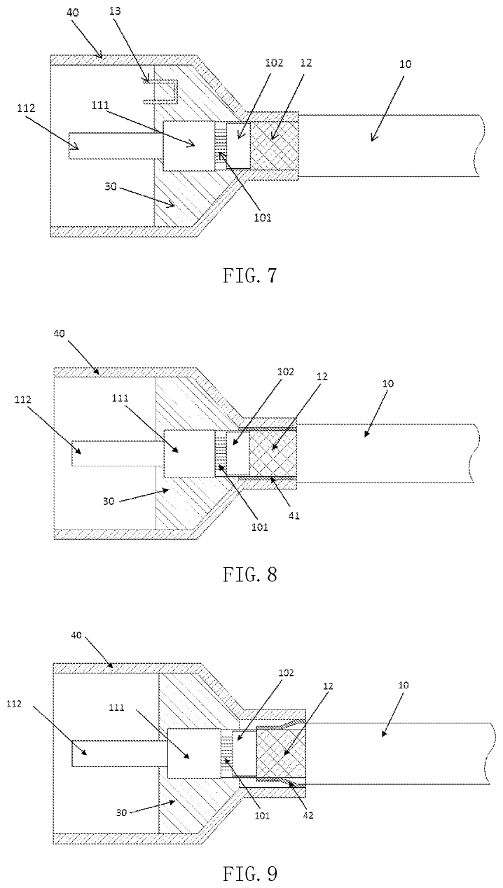

The functional cable 10 is provided with the shielding layer 12, and one end of the protective shielding shell 40 is electrically connected to at least part of the shielding layer 12, as illustrated in FIGS. 7 to 9.

The connection mechanism having a shield in the present disclosure is provided with the inner shell 30 which is integrally injection-molded with the functional cable 10 and the plug-in terminal 11, so that the processing is simple, and the cost is much lower than that of a shielding metal shell. Through a plug-in cooperation between the connection mechanism having a shield and a mating connection mechanism, as well as the electrical connection with the functional cable 10 and the shielding layer 12, it is possible to effectively shield the electromagnetic interference in the connection mechanism, and reduce the electromagnetic interference on other devices.

In an embodiment, the connection mechanism further includes a protective conductor 20 and a grounding terminal 21. One end of the protective shielding shell 40 is at least partially electrically connected to the shielding layer 12, and the other end thereof is at least partially electrically connected to the protective conductor 20 or the grounding terminal 21.

In the present disclosure, the protective shielding shell 40 is electrically connected to not only the shielding layer 12 of the functional cable 10, but also the protective conductor 20 or the grounding terminal 21 to ensure double grounding. Even if the shielding net of the functional cable 10 fails to be grounded, it may be grounded through the protective conductor 20, so that the shielding current can be smoothly led out and the interference of the electromagnetic shielding can be reduced.

In some embodiments, the plug-in terminal 11 and the grounding terminal 21 are made of metal conductive materials which include one or more of nickel, cadmium, zirconium, chromium, cobalt, manganese, aluminum, tin, titanium, zinc, copper, silver, gold, phosphorus, tellurium, beryllium and lead, which are stable in properties and good in electrical conductivity, and the material exemplarily includes copper or copper alloy or aluminum or aluminum alloy.

In some embodiments, the materials of the conductive parts of the functional cable 10 and the protective conductor 20 include one or more of aluminum, phosphorus, tin, copper, iron, manganese, chromium, titanium and lithium, in which the materials of the conductive parts of the functional cable 10 and the protective conductor 20 include aluminum or aluminum alloy, which is one of the main means for energy saving and cost reduction in the near future. In the field of electrical connections, the copper conductor is used for current conduction since copper has high conductivity and good ductility. However, with the increasing price of copper, the material cost of the conductor made of copper is higher and higher. To this end, people begin to look for alternatives to copper to reduce the cost. The content of metallic aluminum in the earth's crust is about 7.73%, and after the optimization of the refining technology, the price thereof is relatively low. In addition, compared with copper, aluminum is lighter, and its conductivity is second only to copper, so that aluminum can partially replace copper in the field of electrical connections. Therefore, replacing copper with aluminum is the development trend in the field of electrical connections of automobiles.

In an embodiment, the protective shielding shell 40 includes a shielding device 41 at least partially electrically connected to the shielding layer 12, as illustrated in FIG. 8.

The protective shielding shell 40 includes the shielding device 41, which is in contact with and electrically connected to the shielding layer 12 form a closed electromagnetic shielding structure to optimize the electromagnetic shielding effect, thereby effectively controlling the radiation of electromagnetic waves and achieving a good shielding effect, as illustrated in FIGS. 8 and 9.

The shielding layer 12 may be a shielding net or a conductive foil. The shielding layer 12 is a flexible structure, while the common terminal shielding device 41 is usually a rigid structure, and when they are in contact, the shielding device 41 and the shielding layer 12 are temporarily disconnected due to the deformation of the shielding layer 12, so that the impedance at a contact point changes, which leads to the unstable shielding effect of the connection structure of the functional cable 10, thereby affecting the signal transmission. Therefore, it is necessary to achieve a stable connection between the shielding device 41 and the shielding layer 12, and the shielding device 41 is generally a rigid structure, which is convenient for the functional cable 10 to form a good electrical connection with the protective shielding shell 40, thereby achieving a stable shielding effect.

In an embodiment, an inner surface of the protective shielding shell 40 is further provided with an electrically-conductive elastic sheet 42, which is in contacted connection with the shielding layer 12 and applies a pressure thereto, as illustrated in FIG. 9.

The protective shielding shell 40 is electrically connected to the shielding layer 12 through the electrically-conductive elastic sheet 42. At least part of the electrically-conductive elastic sheet 42 is elastic, which tends to contract inward to compress the functional cable 10. On the one hand, the stability of the electrical connection between the protective shielding shell 40 and the shielding layer 12 is ensured, and on the other hand, the functional cable 10 can be in contacted connection with the electrically-conductive elastic sheet 42 when being inserted into the protective shielding shell 40, which saves the assembly and processing time, as illustrated in FIGS. 7 to 9.

Further, the pressure applied by the electrically-conductive elastic sheet 42 is in a range of 0.3 N to 95 N.

In order to verify the influence of the pressure applied by the electrically-conductive elastic sheet 42 to the shielding layer 12 on the contact resistance between the electrically-conductive elastic sheet 42 and the shielding layer 12, the inventor carries out targeted tests. Taking the pressure applied by the electrically-conductive elastic sheet 42 to the shielding layer 12 as an example, the inventor selects the electrically-conductive elastic sheet 42 and the shielding layer 12 with the same shape and size, and designs different pressures between the electrically-conductive elastic sheet 42 and the shielding layer 12 to observe the contact resistance therebetween.

The test method of the contact resistance is to adopt a micro-resistance measuring instrument to measure the resistance at the contact position between the electrically-conductive elastic sheet 42 and the shielding layer 12, and read the value on the micro-resistance measuring instrument. In this embodiment, the contact resistance less than 50 μΩ is an ideal value.

TABLE 1
Influence of different pressures between the electrically-conductive
elastic sheet and the shielding layer on the contact resistance
Pressure applied by the electrically-conductive elastic sheet 42 to the shielding layer 12 (N)

| | | | | | | | | | | | | | | | | | |
|---|---|---|---|---|---|---|---|---|---|---|---|---|---|---|---|---|---|
| 0.1 | 0.2 | 0.3 | 0.5 | 1 | 5 | 10 | 20 | 30 | 40 | 50 | 60 | 70 | 80 | 90 | 95 | 100 | 105 |

Contact resistance (μΩ)

| | | | | | | | | | | | | | | | | | |
|---|---|---|---|---|---|---|---|---|---|---|---|---|---|---|---|---|---|
| 64 | 58 | 49 | 43 | 40 | 38 | 35 | 33 | 29 | 26 | 22 | 18 | 14 | 12 | 12 | 10 | 10 | 9 |

As can be seen from Table 1, when the pressure between the electrically-conductive elastic sheet 42 and the shielding layer 12 is less than 0.3 N, the contact resistance therebetween is higher than the ideal value since a bonding force is too small, which does not meet the requirement. When the pressure between the electrically-conductive elastic sheet 42 and the shielding layer 12 is greater than 95 N, the contact resistance does not decrease obviously, but the material selection and processing are more difficult, and the shielding layer 12 will be damaged if the pressure is too high. Therefore, the inventor sets the pressure applied by the electrically-conductive elastic sheet 42 to be between 0.3 N to 95 N.

In addition, the inventor finds that when the pressure between the electrically-conductive elastic sheet 42 and the shielding layer 12 is greater than 0.5 N, the contact resistance therebetween is good, and the decreasing trend is very fast. When the pressure between the electrically-conductive elastic sheet 42 and the shielding layer 12 is less than 50 N, it is convenient to manufacture, mount and use the electrically-conductive elastic sheet with a low cost. Therefore, the inventor prefers that the pressure applied by the electrically-conductive elastic sheet 42 is in a range of 0.5 N to 50 N.

In an embodiment, the electrically-conductive elastic sheet 42 and the protective shielding shell 40 may be connected by welding, adhesion, integral injection-molding, embedding or clamping.

The welding includes laser welding, ultrasonic welding, resistance welding, pressure diffusion welding or soldering. The welding uses the concentrated heat energy or pressure to achieve a fused connection between the contact parts of the electrically-conductive elastic sheet 42 and the inner surface of the protective shielding shell 40. The welding achieves a stable connection, and can also realize the connection between different materials. Since the contact parts are fused, the conductive effect is better.

The adhesion is to use a conductive adhesive to adhere the electrically-conductive elastic sheet 42 and the inner surface of the protective shielding shell 40 together. In this way, no device is needed, and the electrically-conductive elastic sheet 42 and the inner surface of the protective shielding shell 40 can be fully electrically connected through the conductive adhesive. The conductive effect is good, but the connection strength is low, so the adhesion is suitable for a use environment where the connection strength is not required to be high and the melting point or strength of the connection between the electrically-conductive elastic sheet 42 and the inner surface of the protective shielding shell 40 is low.

The integrated injection-molding is that the electrically-conductive elastic sheet 42 is put into an injection-mold, and directly injected onto the inner surface of the protective shielding shell 40 when the connection mechanism is processed. The processing is simple and quick, and there is no other assembly process, thereby saving the assembly time.

The embedding is to dispose a groove on the inner surface of the protective shielding shell 40, and then embed the electrically-conductive elastic sheet 42 into the groove to fix the electrically-conductive elastic sheet 42 on the inner surface of the protective shielding shell 40.

The clamping is to dispose a claw or slot on the inner surface of the protective shielding shell 40, and dispose a corresponding slot or claw on the electrically-conductive elastic sheet 42, then assemble the claw and the slot to fix the electrically-conductive elastic sheet 42 on the inner surface of the protective shielding shell 40.

In the present disclosure, the protective shielding shell is connected to the shielding layer 12 of the functional cable 10 in various ways, so that the protective shielding shell can be stably and effectively connected to the shielding net, thereby achieving a better shielding effect.

In an embodiment, an impedance between the protective shielding shell 40 and the shielding layer 12 is less than 80 mΩ.

The impedance between the protective shielding shell 40 and the shielding layer 12 should be as low as possible, so that the current generated by the shielding layer 12 can flow back to an energy source or a grounding position without hindrance. If the impedance between the protective shielding shell 40 and the shielding layer 12 is large, large current may be generated therebetween, thereby causing a significant radiation at the connection position between the functional cable 10 and the plug-in terminal 11.

Taking the influence of the impedance between the protective shielding shell 40 and the shielding layer 12 on the shielding effect of the connection mechanism having a shield as an example, the inventor selects the functional cable 10 and the plug-in terminal 11 with the same specification, and different impedances between the protective shielding shell 40 and the shielding layer 12 to make the samples of the connection structure of the connection mechanism having a shield, and seals an opening of the protective shielding shell 40 with a metal shielding device to ensure that the whole protective shielding shell 40 is in a completely shielded state, so as to test the shielding effects of the connection mechanism having a shield respectively, and the experimental results are shown in Table 2. In this embodiment, a shielding performance value greater than 40 dB is an ideal value.

The method for testing the shielding performance value is: a test instrument outputs a signal value (which is a test value 2) to the protective shielding shell 40 and the shielding layer 12, and dispose a detection device which detects a signal value (which is a test value 1) outside the connection mechanism having a shield. The shielding performance value=the test value 2−the test value 1.

TABLE 2
Influence of the impedance between the protective shielding shell
40 and the shielding layer 12 on the shielding performance

| | Impedance between the protective shielding shell 40 and the shielding layer 12 (mΩ) | | | | | | | | | | |
|---|---|---|---|---|---|---|---|---|---|---|---|
| Test parameter | 5 | 10 | 20 | 30 | 40 | 50 | 60 | 70 | 80 | 90 | 100 |
| Shielding | 75 | 73 | 70 | 67 | 64 | 57 | 54 | 47 | 41 | 33 | 28 |
| performance | | | | | | | | | | | |
| value (dB) | | | | | | | | | | | |

As can be seen from Table 2, when the impedance value between the protective shielding shell 40 and the shielding layer 12 is greater than 80 mΩ, the shielding performance value of the connection mechanism having a shield is less than 40 dB, which does not meet the requirement of the ideal value. However, when the impedance value between the protective shielding shell 40 and the shielding layer 12 is less than 80 mΩ, all of the shielding performance values of the connection mechanism having a shield meet the requirement of the ideal value, and the trend is increasingly better. Therefore, the inventor sets the impedance between the protective shielding shell 40 and the shielding layer 12 to be less than 80 mΩ.

In an embodiment, the protective shielding shell 40 has a transfer impedance less than 100 mΩ.

Shielding materials are typically characterized by their transfer impedance to represent the shielding effectiveness of the protective shielding shell 40. The shielding effect gets better as the transfer impedance decreases. The transfer impedance of the protective shielding shell 40 is defined as a ratio of a differential mode voltage U induced by a shield per unit length to current IS passing through a surface of the shield, that is:

Z_{T}=U/I_{S}, so it can be understood that the transfer impedance of the protective shielding shell 40 converts the current thereof into a common mode interference. The transfer impedance should be as small as possible, i.e., a better shielding performance can be obtained by reducing the conversion of common mode interference.

In order to verify the influence of different transfer impedances of the protective shielding shell 40 on the shielding effect of the connection mechanism having a shield, the inventor selects the protective shielding shell 40, the functional cable 10 and the plug-in terminal 11 with the same specification, makes a series of samples of shielded connection structures by using the protective shielding shells 40 with different transfer impedances values, and seals the opening of protective shielding shell 40 with a metallic shielding device to ensure that the whole protective shielding shell 40 is in a completely shielded state, so as to test the shielding effects of the connection mechanism having a shield respectively, and the experimental results are shown in Table 3. In this embodiment, the shielding performance value of the connection mechanism having a shield more than 40 dB is an ideal value.

The method for testing the shielding performance value is: a test instrument outputs a signal value (which is a test value 2) to the connection mechanism having a shield, and dispose a detection device which detects a signal value (which is a test value 1) outside the connection mechanism having a shield. The shielding performance value=the test value 2−the test value 1.

TABLE 3
Influence of the transfer impedance of the protective
shielding shell 40 on the shielding performance

| | Transfer impedance of the protective shielding shell (mΩ) | | | | | | | | | | |
|---|---|---|---|---|---|---|---|---|---|---|---|
| Test parameter | 20 | 30 | 40 | 50 | 60 | 70 | 80 | 90 | 100 | 110 | 120 |
| Shielding | 78 | 75 | 72 | 67 | 62 | 58 | 53 | 50 | 42 | 30 | 28 |
| performance | | | | | | | | | | | |
| value (dB) | | | | | | | | | | | |

As can be seen from Table 3, when the transfer impedance of the protective shielding shell 40 is greater than 100 mΩ, the shielding performance value of the connection mechanism having a shield is less than 40 dB, which does not meet the requirement of the ideal value. When the transfer impedance of the protective shielding shell 40 is less than 100 mΩ, the shielding performance values of the connection structure of all connection mechanisms having a shield meet the requirement of the ideal value, and the trend is increasingly better. Therefore, the inventor sets the transfer impedance of the protective shielding shell 40 to be less than 100 mΩ.

In an embodiment, the material of the protective shielding shell 40 includes one or more of conductive ceramic, carbon-containing conductor, solid electrolyte, mixed conductor and conductive polymer material.

In order to verify the influence of different materials on the electrical conductivity of the protective shielding shell 40, the inventor makes samples of the protective shielding shell 40 using different materials of the same size to test the electrical conductivity of the protective shielding shell 40, and the experimental results are shown in Table 4. In this embodiment, the electrical conductivity of the protective shielding shell 40 greater than 99% is the ideal value.

TABLE 4
Influence of different materials on the electrical
conductivity of the protective shielding shell 40

| | Carbon- | | | Conductive |
|---|---|---|---|---|
| Conductive | containing | Solid | Mixed | polymer |
| ceramic | conductor | electrolyte | conductor | material |
| 99.5% | 99.6% | 99.5% | 99.3% | 99.6% |

As can be seen from Table 4, the electrical conductivity of the protective shielding shell 40 made of any of the selected materials is within the range of the ideal value, so the inventor sets that the protective shielding shell 40 is made of one or more of the conductive ceramic, the carbon-containing conductor, the solid electrolyte, the mixed conductor and the conductive polymer material.

Further, the carbon-containing conductor includes one or more of graphite powder, carbon nanotube material and graphene material.

Further, the conductive polymer material is a polymer material including metal particles, which are made of one or more of nickel, cadmium, zirconium, chromium, cobalt, manganese, aluminum, tin, titanium, zinc, copper, silver, gold, phosphorus, tellurium and beryllium. The polymer material includes one or more of polyvinyl chloride, polyethylene, polyamide, polytetrafluoroethylene, tetrafluoroethylene/hexafluoropropylene copolymer, ethylene/tetrafluoroethylene copolymer, polypropylene, polyvinylidene fluoride, polyurethane, polyterephthalic acid, polyurethane elastomer, styrene block copolymer, perfluoroalkoxy alkane, chlorinated polyethylene, polyphenylene sulfide, polystyrene, silicone rubber, cross-linked polyolefin, ethylene-propylene rubber, ethylene/vinyl acetate copolymer, chloroprene rubber, natural rubber, styrene-butadiene rubber, nitrile rubber, cis-polybutadiene, isoprene rubber, ethylene propylene rubber, chloroprene rubber, butyl rubber, fluororubber, polyurethane rubber, polyacrylate rubber, chlorosulfonated polyethylene rubber, epichlorohydrin rubber, chlorinated polyethylene rubber, chlorosulfide rubber, styrene butadiene rubber, butadiene rubber, hydrogenated nitrile rubber, polysulfide rubber, crosslinked polyethylene, polycarbonate, polysulfone, polystyrene, polyester, phenolic resin, urea formaldehyde, styrene-propylene copolymer, polymethacrylate and polyoxymethylene resin.

The characteristics of the material are illustrated below.

Polyoxymethylene is a kind of hard and dense material with a smooth and shiny surface, which is yellowish or white and can be used for a long time in a temperature range of −40° C. to 100° C. Polyoxymethylene has a wear resistance and a self-lubrication superior to those of most engineering plastics, and also has good oil resistance and peroxide resistance.

Polycarbonate is colorless, transparent, heat-resistant and impact-resistant with a flame-retardant grade BI, and has good mechanical properties under an ordinary use temperature. Compared with polymethyl methacrylate with similar properties, polycarbonate has a good impact resistance, a high refractive index and a good processability, and achieves a very high flame retardant performance without additives.

Polyamide is nontoxic and light, with an excellent mechanical strength and good wear resistance and corrosion resistance. Polyamide can be used to replace metals such as copper to manufacture parts such as bearings, gears and pump blades in the industries of machinery, chemicals, instruments, automobiles, etc. Polycarbonate or polyamide is the first choice for the conductive polymer material.

In an embodiment, the protective shielding shell 40 is manufactured by one or more of an extrusion process, an injection-molding process, a plastic dipping process, a blow molding process, a foaming process, a spraying process, a printing process and a 3D printing process.

The injection-molding process refers to a process of making a semi-finished part with a certain shape by pressing, injecting, cooling and demolding molten raw materials.

The plastic dipping process refers to a process of heating a workpiece to a certain temperature, and then dipping it into a dipping solution so that the dipping solution is solidified on the workpiece.

The blow molding process is to extrude a tubular parison with an extruder, put the tubular parison into a mold while it is hot, and introduce compressed air to inflate the tubular parison to make it reach the shape of a mold cavity, and then obtain a product after cooling and shaping. The advantages are that the blow molding process is suitable for various plastics, capable of producing large-scale products, and has a high production efficiency, a uniform parison temperature and a small device investment.

The foaming process is to form a honeycomb or porous structure through the addition and reaction of a physical foaming agent or a chemical foaming agent in a foaming molding procedure or a foamed polymer material. The basic steps of the foaming molding include a formation of bubble nucleus, a growth or expansion of the bubble nucleus and a stabilization of the bubble nucleus. At the given temperature and pressure, the solubility of gas decreases to reach a saturation state, so that the excess gas is exhausted and bubbles are formed, thereby realizing nucleation.

The spraying process is a coating method in which a spraying material is dispersed into uniform and fine droplets by means of a pressure or a centrifugal force through a spray gun or a disc atomizer, and then applied to a surface of an object to be coated. The spraying process may be classified into air spraying, airless spraying, electrostatic spraying and various derivatives of the above basic spraying forms.

The printing process means using a printing plat to transfer ink or any other viscous fluid material to a surface of an object to be coated, including screen printing, letterpress printing, flexographic printing, gravure printing or planographic printing.

The 3D printing process is one of the rapid prototyping technologies, also known as additive manufacturing. The 3D printing process is a technology based on digital model files, which uses adhesive materials such as powdered metal or plastic to construct an object by printing layer by layer.

In an embodiment, the protective shielding shell 40 is integrally injection-molded with at least part of the shielding layer 12. In the injection-molding process, the protective shielding shell 40 may be injected together with the shielding layer 12 of the functional cable 10, so that the connection mechanism having a shield can realize the electrical connection between the protective shielding shell 40 and the shielding layer 12 without using the shielding device 41, and achieve a better shielding effect.

In an embodiment, the plug-in terminal 11 includes a first fixation portion 111 and a plug-in portion 112 which are sequentially disposed, and the plug-in portion 112 may be barrel-shaped or columnar. The first fixation portion 111 is electrically connected to the conductive part of the functional cable 10, so as to conduct the circuit. The plug-in portion 112 may be barrel-shaped or columnar, and the electrical appliance plugged with the connection mechanism is further provided with terminals, front ends of which are may also be barrel-shaped or columnar, and the columnar or barrel-shaped terminals are plugged with each other to realize a pluggable circuit connection, as illustrated in FIGS. 5 and 6.

Further, the functional cable 10 includes a cable core 101 disposed at an innermost part, a shielding layer 12 sleeved around an outer periphery of the cable core 101, and an insulation layer 102 sleeved around an outer periphery of the shielding layer 12, in which the first fixation portion 111 is electrically connected to a conductive part of the cable core 101. The functional cable 10 may be composed of a plurality of core wires each representing a different loop, the number of the plug-in terminals 11 is the same as that of the core wires, and the first fixation portions 111 of the plurality of plug-in terminals 11 are electrically connected to conductive parts of the plurality of core wires respectively. The shielding layer 12 sleeved around the outer periphery of the cable core 101 is electrically connected to the protective shielding shell 40 to shield the signal interference. The insulation layer 102 sleeved around the outer periphery of the shielding layer 12 plays the role of insulation protection, and prevents the internal plug-in terminal 11, the cable core 101 and the shielding layer 12 from contacting an external conductor to cause a short circuit, as illustrated in FIGS. 7 to 9.

Further, the first fixation portion 111 and the conductive part of the cable core 101 are connected by one or more of resistance welding, friction welding, ultrasonic welding, arc welding, laser welding, electron beam welding, pressure diffusion welding, magnetic induction welding, screwing, clamping, splicing and crimping.

The resistance welding refers to a method of welding by causing strong current to pass through a contact point between an electrode and a workpiece and generating heat by a contact resistance. The first fixation portion 111 and the conductive part of the cable core 101 are welded by the resistance welding.

The friction welding refers to a method of welding by taking heat generated by the friction between contact surfaces of workpieces as a heat source to plastically deform the workpieces under pressure. The first fixation portion 111 and the conductive part of the cable core 101 are welded by the friction welding.

The ultrasonic welding is to transmit high-frequency vibration waves to the surfaces of two objects to be welded, so that under pressure, the surfaces of the two objects rub against each other to fuse molecular layers. The first fixation portion 111 and the conductive part of the cable core 101 are welded by the ultrasonic welding.

The arc welding is to convert electric energy into heat energy and mechanical energy required for welding by taking an electric arc as a heat source and utilizing the physical phenomenon of air discharge, so as to connect metals. The arc welding mainly includes shielded metal arc welding, submerged arc welding, gas shielded welding, etc.

The laser welding is an efficient and precise welding method by taking a laser beam of a high energy density as a heat source.

The electron beam welding is to use accelerated and focused electron beams to bombard welding surfaces placed in vacuum or non-vacuum, so that the workpieces to be welded can be melted to realize welding.

The pressure welding is a method of applying a pressure to the workpieces to be welded to make joint surfaces closely contact and produce certain plastic deformation to complete the welding.

The diffusion welding refers to a solid-state welding method that pressurizes the workpieces at a high temperature without visible deformation and relative movement.

The magnetic induction welding means that two workpieces to be welded are subjected to instantaneous high-speed collision under the action of a strong pulse magnetic field, and the atoms of two materials meet within an inter-atomic distance under the action of high-voltage waves on the surfaces of the materials, thereby forming a stable metallurgical bonding on the interface. The magnetic induction welding is a kind of solid-state cold welding, and can weld the first fixation portion 111 and the first cable with similar or dissimilar properties together.

The screwing refers to a threaded connection, which is a detachable connection in which a threaded piece (or the threaded part of a piece to be connected) is used to connect the pieces to be connected into a whole. The conventional threaded connecting pieces include a bolt, a stud, a screw, a set screw, etc., mostly of which are standard parts.

The clamping means that the connecting end and the connecting surface are provided with a corresponding claw or slot, respectively, and an assembly is made by connecting the slot and the claw together. The clamping has the advantages of quick connection and detachability.

The splicing means that the connecting end and the connecting surface are provided with a corresponding groove and protrusion, respectively, and an assembly is made by connecting the groove and the protrusion together by means of tenoning or splicing. The splicing has the advantages of stable connection and detachability.

The crimping is a production process in which the connecting end and the connecting surface are assembled and then stamped into a whole using a crimping machine. The crimping has the advantage of mass production, and by adopting an automatic crimping machine, products with a stable quality can be rapidly manufactured in large quantities.

Based on the above connection modes, an appropriate connection mode or combination thereof can be selected according to the actual use environment and the actual use state of the first fixation portion 111 and the conductive part of the cable core 101, so as to realize an effective electrical connection.

In an embodiment, the plug-in portion 112 is columnar and at least partially protrudes from the inner shell 30, or the inner shell 30 has a groove and the plug-in portion 112 at least partially protrudes from a bottom surface of the groove without exceeding the inner shell 30. The plug-in portion 112 protrudes from the inner shell 30, so as to be plugged with a recessed grounding terminal 21 in the to-be-plugged electrical appliance to realize an electrical connection. Alternatively, the inner shell 30 has a groove, the plug-in portion 112 protrudes from a bottom surface of the groove, and the to-be-plugged electrical appliance has a protruding grounding terminal 21, which is plugged with the plug-in portion 112 in the groove to realize an electrical connection, as illustrated in FIG. 5.

In an embodiment, the plug-in portion 112 is barrel-shaped, and at least partially protrudes from an outer wall of the inner shell 30, or the inner shell 30 is provided with an open boss in which the plug-in portion 112 is at least partially disposed. The plug-in portion 112 protrudes from the outer wall of the inner shell 30, and may be plugged with a recessed plug-in portion 212 in the to-be-plugged electrical appliance to realize an electrical connection. Alternatively, the inner shell 30 has an open boss in which the plug-in portion 112 is disposed, and the to-be-plugged electrical appliance has a protruding grounding terminal 21 to be plugged with the plug-in portion 112 in the open boss to realize an electrical connection, as illustrated in FIG. 6.

In an embodiment, the protective shielding shell 40 at least wraps the first fixation portion 111 and at least part of the functional cable 10, but is insulated from the plug-in terminal 11 and the conductive part of the functional cable 10. Since the plug-in terminal 11 and the cable core 101 are the sources of interference signals, the protective shielding shell 40 at least wraps the plug-in terminal 11 and the cable core 101 in order to shield the interference signals. Since the plug-in portion 112 is plugged with the plug-in portion 212 to realize an electrical connection, the protective shielding shell 40 also needs to form a shielding mechanism together with the electrical appliance, but the protective shielding shell 40 should at least wrap the first fixation portion 111. In addition, the functional cable 10 shields the signals mostly by the shielding layer 12, and only a part of the shielding layer 12 extending into the protective shielding shell 40 needs to be stripped and electrically connected to the protective shielding shell 40. Thus, the protective shielding shell 40 at least wraps the first fixation portion 111 and at least part of the functional cable 10, as illustrated in FIGS. 7 to 9.

In an embodiment, the inner shell 30 is integrally injection-molded on outer peripheries of at least the first fixation portion 111, the plug-in terminal 11 and the conductive part of the functional cable 10, and achieves an insulation effect. By means of integral injection-molding, the inner shell 30 can be directly molded on the outer peripheries of at least the first fixation portion 111, the plug-in terminal 11 and the conductive part of the functional cable 10, thereby ensuring that the plug-in terminal 11 and the conductive part of the functional cable 10 will not be connected to any other external conductor to cause a short circuit.

Further, the protective shielding shell 40 wraps and is integrally injection-molded on at least part of the outer periphery of the inner shell 30. By means of integral injection-molding, the protective shielding shell 40 can be directly formed on part of the outer periphery of the inner shell 30, and directly connected to the shielding layer 12, thereby realizing a good signal shielding function.

In an embodiment, the outer periphery of the inner shell 30 and/or the protective shielding shell 40 is further integrally injection-molded with an outer insulation shell 50, which wraps at least part of the inner shell 30 and/or the protective shielding shell 40 as well as at least part of the functional cable 10 and the protective conductor 20. By means of integral injection-molding, the outer insulation shell 50 can be directly molded on the outer periphery of the inner shell 30 and/or the protective shielding shell 40, thereby ensuring that the protective shielding shell will not be connected to any other external conductor to cause a short circuit.

In an embodiment, the connection mechanism having a shield includes an interlocking connection mechanism 13, which is at least partially integrally injection-molded in the inner shell 30. High-voltage interlocking is a safety design method to monitor the integrity of a high-voltage loop with a low-voltage signal. Different projects have different designs for the implementation of the high-voltage interlocking. The high-voltage interlocking is to monitor the accidental disconnection of the high-voltage loop to avoid the damage to the automobile due to the sudden loss of power. As illustrated in FIG. 7, the interlocking connection mechanism 13 in this embodiment is a U-shaped or V-shaped low-voltage loop with two plug-in pins electrically connected to each other. The interlocking connection mechanism 13 does not need to be mounted, but may be directly formed in the inner shell 12 by means of integral injection-molding, and matched with and connected to a high-voltage interlocking structure in a mating mechanism to form a low-voltage monitoring loop. When the connection mechanism having a shield in this embodiment is accidentally disconnected, the interlocking connection mechanism 13 and the high-voltage interlocking structure are disconnected at the same time, and the low-voltage monitoring loop gives an alarm to a central control system, so as to prevent the automobile from being damaged due to the sudden loss of power.

In an embodiment, the grounding terminal 21 includes a second fixation portion 211 and a plug-in portion 222, in which the second fixation portion 211 is electrically connected to the protective conductor 20, and the plug-in portion 212 is barrel-shaped or columnar. The second fixation portion 211 is electrically connected to a conductive part of the protective conductor 20, so as to conduct the circuit. The plug-in portion 212 may be barrel-shaped or columnar, and the electrical appliance plugged with the connection mechanism is further provided with terminals, front ends of which are may also be barrel-shaped or columnar, and the columnar or barrel-shaped terminals are plugged with each other to realize a pluggable circuit connection, as illustrated in FIGS. 5 and 6.

Further, the second fixation portion 211 and the conductive part of the protective conductor 20 are connected by one or more of resistance welding, friction welding, ultrasonic welding, arc welding, laser welding, electron beam welding, pressure diffusion welding, magnetic induction welding, screwing, clamping, splicing and crimping. Here, the connection mode is the same as that for the first fixation portion 111 and the functional cable 10.

In an embodiment, the plug-in portion 212 is columnar and at least partially protrudes from the inner shell 30, or the inner shell 30 has a groove and the plug-in portion 212 at least partially protrudes from a bottom surface of the groove without exceeding the inner shell 30. The plug-in portion 212 protrudes from the inner shell 30, so as to be plugged with the recessed grounding terminal 21 in the to-be-plugged electrical appliance to realize an electrical connection. Alternatively, the inner shell 30 has a groove, the plug-in portion 212 protrudes from a bottom surface of the groove, and the to-be-plugged electrical appliance has a protruding grounding terminal 21, which is plugged with the plug-in portion 212 in the groove to realize an electrical connection, as illustrated in FIG. 5.

In an embodiment, the plug-in portion 212 is barrel-shaped, and at least partially protrudes from an outer wall of the inner shell 30, or the inner shell 30 is provided with an open boss in which the plug-in portion 212 is at least partially disposed. The plug-in portion 212 protrudes from the outer wall of the inner shell 30, and may be plugged with the recessed grounding terminal 21 in the to-be-plugged electrical appliance to realize an electrical connection. Alternatively, the inner shell 30 has an open boss in which the plug-in portion 212 is disposed, and the to-be-plugged electrical appliance has a protruding grounding terminal 21 to be plugged with the plug-in portion 212 in the open boss to realize an electrical connection, as illustrated in FIG. 6.

In an embodiment, the inner shell 30 is integrally injection-molded on outer peripheries of at least the second fixation portion 211 and the conductive part of the protective conductor 20, and achieves an insulation effect. By means of integral injection-molding, the inner shell 30 can be directly molded on the outer peripheries of at least the second fixation portion 211 and the conductive part of the protective conductor 20, thereby ensuring that the grounding terminal 21 and the conductive part of the protective conductor 20 will not be connected to any other external conductor to cause a short circuit.

In an embodiment, the protective shielding shell 40 at least wraps the outer periphery of the second fixation portion 211 and/or the conductive part of the protective conductor 20, and the protective shielding shell 40 is electrically connected to the second fixation portion 211 and/or the conductive part of the protective conductor 20.

In the present disclosure, the protective shielding shell 40 is electrically connected to not only the shielding net of the functional cable, but also the protective conductor 20 or the grounding terminal to ensure double grounding. Even if the shielding net of the functional cable fails to be grounded, it may be grounded through the protective conductor 20, so that the shielding current can be smoothly led out and the interference of the electromagnetic shielding can be reduced.

In an embodiment, the connection mechanism has a seal structure 60, which is secondarily injection-molded on the inner shell 30 and/or the protective shielding shell 40. The seal structure 60 can achieve a tighter connection between the connection mechanism and the to-be-plugged electrical appliance. The seal structure 60 of the connection mechanism is no longer a separate seal ring, but adopts a secondarily injection-molded seal structure 60 to replace the traditional seal ring, so as to be directly molded on the connection mechanism, thereby achieving a better injection bonding and a lower cost.

In an embodiment, the connection mechanism has a seal structure 60, which is secondarily injection-molded on the outer insulation shell 50. The seal structure 60 can achieve a tighter connection between the connection mechanism and the to-be-plugged electrical appliance.

Further, the seal structure 60 is made of rubber, soft rubber or silica gel. These materials can be heated and melted by an injection-molding machine and injected into a corresponding mold for molding, so that the processing is simple and the bonding is firm, and the service life of the seal structure 60 can be greatly prolonged. In addition, these materials have good elasticity and can be extruded and deformed to fill the gaps when the connection mechanism is assembled, thereby achieving a good sealing performance. Moreover, these materials are water-resistant and oil-resistant, thereby ensuring a long service life and a safe sealing performance of the seal structure 60.

A maximum gap between the seal structure 60 and the inner shell 30 and/or the protective shielding shell 40 is less than 520 nm.

In order to verify the influence of the gap between each seal structure 60 and the adjacent device on the sealing grade, the inventor adopts a dry air method to test the sealing device. By vacuumizing or air pressurization, the internal and external pressures of the tested sample are controlled to be different, and the difference between the internal and external pressures will decrease if there is a leakage, so that the sealability can be detected by detecting the change of the air pressure. The detection medium is dry air, which is non-toxic and harmless without damaging the tested sample, and the detection environment is clean and tidy. For example, in the detection of the seal structure 60 disposed on the inner shell 30, the inventor completely seals other joints after the connection between the inner shell 30 and the protective shielding shell 40, selects the seal structures with different sealing degrees and partially extracts the dry air therein, so that the air pressure in the seal structure is lower than the external air pressure, and continuously detects the air pressure in the seal structure. It is unqualified when the air pressure increases, and the test results are shown in Table 5.

TABLE 5
Influence of the maximum gap between the seal structure 60 and the inner shell
30 and/or the protective shielding shell 40 on the change of the air pressure

| | Maximum gap (nm) | | | | | | | | |
|---|---|---|---|---|---|---|---|---|---|
| | 530 | 520 | 500 | 450 | 400 | 350 | 300 | 280 | 260 |
| Whether the | Yes | No | No | No | No | No | No | No | No |
| air pressure | | | | | | | | | |
| changes | | | | | | | | | |

As can be seen from Table 5, when the maximum gap between the seal structure 60 and the inner shell 30 and/or the protective shielding shell 40 exceeds 520 nm, the air pressure changes, which means that air enters the seal structure 60 and the test result is unqualified. Therefore, the inventor selects the maximum gap between the seal structure 60 and the inner shell 30 and/or the protective shielding shell 40 to be not less than 520 nm.

In an embodiment, the connection mechanism has at least one temperature measuring structure for measuring the temperature of the plug-in terminal 11 and/or the grounding terminal 21. The temperature measuring structure may be at a distance from the plug-in terminal 11 and/or the grounding terminal 21. The heat radiation is transmitted to the temperature measuring structure from the plug-in terminal 11 and/or the grounding terminal 21, and then the temperature of the plug-in terminal 11 and/or the grounding terminal 21 is measured by the temperature measuring structure; or the temperature measuring structure includes a conductive element attached to the plug-in terminal 11 and/or the grounding terminal 21, the temperature of the plug-in terminal 11 and/or the grounding terminal 21 is measured from the temperature transmitted by the conductive element, and the measured temperature is transmitted to the control system, so as to adjust the current passing through the plug-in terminal 11 and/or the flat band 11, thereby adjusting the temperature of the connection mechanism 10.

Further, the temperature measuring structure is attached to the plug-in terminal 11 and/or the grounding terminal 21. The temperature measuring structure is a temperature sensor, which is directly attached to the plug-in terminal 11 and/or the grounding terminal 21, thereby directly obtaining the actual temperature thereof without calculation. The structure is simple and the temperature measurement is more accurate.

The temperature sensor may be an NTC temperature sensor or a PTC temperature sensor. These two temperature sensors are advantageous in that they are small in size and can measure gaps that cannot be measured by other thermometers; the usage is convenient, and the resistance value can be arbitrarily selected between 0.1 kΩ and 100 kΩ; and the temperature sensors are easy to be processed into complex shapes, can be produced in large quantities, have good stability and strong overload capacity, and are suitable for products such as adapters requiring small sizes and stable performances.

By adopting the temperature measuring structure, it is possible to separately monitor the terminal temperature inside the connection mechanism, and avoid the situation that the temperature of the connection mechanism cannot be monitored due to the damage of the temperature sensors in other positions.

In an embodiment, the material of the plug-in terminal 11 or the grounding terminal 21 includes one or more of nickel, cadmium, zirconium, chromium, cobalt, manganese, aluminum, tin, titanium, zinc, copper, silver, gold, phosphorus, tellurium and beryllium.

In order to verify the influence of different materials on the electrical conductivity of the plug-in terminal 11 or the grounding terminal 21, the inventor takes the grounding terminal 21 as an example, makes the samples of the grounding terminal 11 with different materials of the same size to test the electrical conductivity of the grounding terminal 21 respectively, and the experimental results are shown in Table 6. In this embodiment, the electrical conductivity of the grounding terminal 21 greater than 99% is an ideal value.

TABLE 6
Influence of different materials on the electrical conductivity of the grounding terminal 21
Different materials of the grounding terminal 21

| | | | | | | | | | | | | | | |
|---|---|---|---|---|---|---|---|---|---|---|---|---|---|---|
| Nickel | Cadmium | Zirconium | Chrome | Cobalt | Manganese | Aluminum | Tin | Titanite | Zinc | Copper | Silver | Gold | Tellurium | Beryllium |

electrical conductivity of the grounding terminal 21 (%)

| | | | | | | | | | | | | | | |
|---|---|---|---|---|---|---|---|---|---|---|---|---|---|---|
| 99.4 | 99.3 | 99.2 | 99.2 | 99.2 | 99.3 | 99.6 | 99.5 | 99.4 | 99.3 | 99.7 | 99.9 | 99.7 | 99.4 | 99.3 |

As can be seen from Table 6, the electrical conductivity of the grounding terminal 21 made of any of the selected metallic materials is within the range of the ideal value. In addition, phosphorus is a nonmetallic material, which cannot be directly used as the material of a metal insert, but may be added into other metal to form an alloy to improve the electrical conductivity and mechanical properties of the metal. Therefore, the inventor sets that the material of the grounding terminal 21 includes one or more of nickel, cadmium, zirconium, chromium, cobalt, manganese, aluminum, tin, titanium, zinc, copper, silver, gold, phosphorus, tellurium and beryllium.

In an embodiment, the material of the functional cable 10 or the conductive part of the protective conductor 20 includes one or more of aluminum, phosphorus, tin, copper, iron, manganese, chromium, titanium and lithium.

In order to verify the influence of different materials on the electrical conductivity of the functional cable 10 or the protective conductor 20, the inventor takes the functional cable 10 as an example, makes the samples of the functional cable 10 with different materials of the same size to test the electrical conductivity of the functional cable 10 respectively, and the experimental results are shown in Table 7. In this embodiment, the electrical conductivity of the functional cable 10 greater than 99% is an ideal value.

TABLE 7
Influence of different materials on the electrical conductivity of the functional cable 10

| Aluminum | Tin | Copper | Iron | Manganese | Chrome | Titanium | Lithium | Nickel | Cadmium | Cobalt |
|---|---|---|---|---|---|---|---|---|---|---|
| 99.4 | 99.3 | 99.3 | 99.2 | 99.3 | 99.4 | 99.6 | 99.5 | 98.7 | 98.9 | 98.7 |

As can be seen from Table 7, the electrical conductivity of the functional cable 10 made of any of the selected metallic materials is within the range of the ideal value, and other materials cannot meet the requirement. In addition, phosphorus is a nonmetallic material, which cannot be directly used as the material of the functional cable 10, but may be added into other metal to form an alloy to improve the electrical conductivity and mechanical properties of the metal. Therefore, the inventor sets that the material of the functional cable 10 or the conductive part of the protective conductor 20 includes one or more of aluminum, phosphorus, tin, copper, iron, manganese, chromium, titanium and lithium.

Moreover, the material of the functional cable 10 or the protective conductor 20 includes (or is) aluminum. When the material of the functional cable 10 or the protective conductor 20 is aluminum, the functional cable 10 or the protective conductor 20 is an aluminum cable for charging, which has an excellent electrical performance and a density ⅓ of that of copper. Thus, the weight of the aluminum cable is smaller than that of the copper harness, and the cost of aluminum is lower than that of copper.

In an embodiment, the weight of the connection mechanism is less than or equal to 272 g. When the weight is too large, the connection mechanism receives a large gravity, so that the whole connection mechanism vibrates along with a vibration of the electrical appliance. Due to inertia, the connection mechanism will be subjected to a large vibration, resulting in abnormal sound which is not allowed during the use of the electrical appliance.

In order to verify the influence of the weight of the connection mechanism on the abnormal sound thereof, the inventor adopts the samples of the connection mechanism with different weights which are mounted on a vibration test bench after being assembled with the mating electrical appliance, and then carries out a vibration test to observe whether the connection mechanism generates abnormal sound during the vibration test. The test results are shown in Table 8.

TABLE 8
Influence of the weight of the connection
mechanism on the abnormal sound thereof

| | Weight (g) | | | | | | | | |
|---|---|---|---|---|---|---|---|---|---|
| | 232 | 242 | 252 | 262 | 272 | 282 | 292 | 302 | 312 |
| Whether there is | No | No | No | No | No | Yes | Yes | Yes | Yes |
| abnormal sound | | | | | | | | | |

As can be seen from Table 8, when the weight of the connection mechanism is greater than 272 g, the connection mechanism generates abnormal sound during the vibration test, and the test result is unqualified. Therefore, the inventor selects the weight of the connection mechanism to be less than or equal to 272 g.

In an embodiment, the height of the connection mechanism along a insertion direction is less than or equal to 274 mm. The connection mechanism should be mounted in the electrical appliance. However, the space reserved in the electrical appliance is generally small, and when the connection mechanism is high, it usually cannot be mounted into the electrical appliance and the raw material will be wasted. Therefore, the connection mechanism should be lower than a certain height during the design.

In order to verify the influence of the height of the connection mechanism along the insertion direction on the mounting of the connection mechanism, the inventor adopts the samples of the connection mechanism with different heights along the insertion direction which are mounted on the electrical appliance after being assembled, and observes whether the connection mechanism interferes with other parts of the electrical appliance during mounting. The test results are shown in Table 9.

TABLE 9
Influence of the height of the connection mechanism along the
insertion direction on the mounting of the connection mechanism

| | Height (mm) | | | | | | | | |
|---|---|---|---|---|---|---|---|---|---|
| | 234 | 244 | 254 | 264 | 274 | 284 | 294 | 304 | 314 |
| Whether there | No | No | No | No | No | Yes | Yes | Yes | Yes |
| is interference | | | | | | | | | |

As can be seen from Table 9, when the height along the insertion direction is greater than 274 mm, the connection mechanism cannot be mounted in the designated position of the electrical appliance, and the test result is unqualified. The inventor selects the height of the connection mechanism along the insertion direction to be less than or equal to 274 mm.

In an embodiment, at least part of the surface of the plug-in terminal 11 and/or the grounding terminal 21 is provided with a conductive anticorrosion layer.

When the materials of the plug-in terminal 23 and the grounding terminal 21 are different from the material of the mating terminal, the electrical conduction therebetween will cause an electrochemical corrosion due to a potential difference, thereby reducing the service lives of the plug-in terminal 11 and the grounding terminal 21. In order to reduce the electrochemical corrosion, at least part of the surfaces of the plug-in terminal 11 and the grounding terminal 21 may be provided with a conductive anticorrosion layer, which may be made of a metal material with a potential between the potential of the materials of the plug-in terminal 23 and the grounding terminal 21 and the potential of the material of the mating terminal, thereby isolating the plug-in terminal 11 and the grounding terminal 21 from the mating terminal, slowing down the electrochemical corrosion, and prolonging the service lives of the plug-in terminal 11 and the grounding terminal 21.

Further, the conductive anticorrosion layer is attached to at least part of the surface of the plug-in terminal 11 and/or the grounding terminal 21 by one or more of electroplating, electroless plating, magnetron sputtering, vacuum plating, pressure welding, diffusion welding, friction welding, resistance welding, ultrasonic welding or laser welding.

The electroplating is a process of plating a thin layer of other metal or alloy on a surface of some metal by using a principle of electrolysis.

The electroless plating is a deposition process in which a metal is produced through a controllable oxidation-reduction reaction under a metal catalytic action.

The magnetron sputtering is to use an interaction between a magnetic field and an electric field to make electrons move spirally near a target surface, thereby increasing the probability that the electrons bombard argon to generate ions. The generated ions bombard the target surface under the action of the electric field so as to sputter a target material.

The vacuum plating is to deposit various metal and non-metal films on the surface of a molded piece by means of distillation or sputtering under vacuum conditions.

The pressure welding is a method of applying a pressure to the workpieces to be welded to make joint surfaces closely contact and produce certain plastic deformation to complete the welding.

The friction welding refers to a method of welding by taking heat generated by the friction between contact surfaces of workpieces as a heat source to plastically deform the workpieces under pressure.

The resistance welding refers to a method of welding by using strong current to pass through a contact point between an electrode and a workpiece and generating heat by a contact resistance.

The ultrasonic welding is to transmit high-frequency vibration waves to the surfaces of two objects to be welded, so that under pressure, the surfaces of the two objects rub against each other to fuse molecular layers.

The laser welding is an efficient and precise welding method using a laser beam of a high energy density as a heat source.

The diffusion welding refers to a solid-state welding method that pressurizes the workpieces at a high temperature without visible deformation and relative movement. The conductive anticorrosion layer can be stably disposed on at least part of the surface of the plug-in terminal 11 and/or the grounding terminal 21 by adopting one of the above modes or combinations thereof.

In an embodiment, the conductive anticorrosion layer has a thickness of 0.3 μm to 3000 μm.

In an embodiment, the conductive anticorrosion layer has a thickness of 2.5 μm to 1000μ m.

In order to test the influence of different thicknesses of the conductive anticorrosion layers on a voltage drop, the inventor adopts the plug-in terminal 11 and the grounding terminal 21 of the same material and structure, disposes the conductive anticorrosion layers with different thicknesses on at least part of the surfaces of the plug-in terminal 11 and the grounding terminal 21, respectively, and tests the voltage drop after plug-in the plug-in terminal 11 and the grounding terminal 21 with the mating terminal. The results are shown in Table 10.

In this embodiment, it is unqualified when the voltage drop after plug-in the plug-in terminal 11 and the grounding terminal 21 with the mating terminal is greater than 4 mV.

TABLE 10
Influence of different thicknesses of the conductive anticorrosion layer on the voltage drop (mV)
Thicknesses of the conductive anticorrosion layer (μm)

| | 0.2 | 0.3 | 1 | 2.5 | 5 | 10 | 50 | 100 | 300 | 500 | 800 | 1000 | 2000 | 3000 | 4000 |
|---|---|---|---|---|---|---|---|---|---|---|---|---|---|---|---|
| Serial No. | Voltage drop after plug-in (mV) | | | | | | | | | | | | | | |
| 1 | 4.2 | 3.4 | 3.3 | 3.1 | 3.2 | 3.4 | 3.5 | 3.7 | 3.6 | 3.7 | 3.8 | 3.8 | 3.8 | 3.8 | 4.2 |
| 2 | 4.1 | 3.4 | 3.3 | 3.2 | 3.3 | 3.5 | 3.6 | 3.5 | 3.6 | 3.6 | 3.7 | 3.8 | 3.9 | 3.9 | 4.2 |
| 3 | 4.2 | 3.4 | 3.2 | 3.1 | 3.2 | 3.4 | 3.5 | 3.7 | 3.5 | 3.7 | 3.8 | 3.8 | 3.8 | 3.8 | 4.1 |
| 4 | 4.2 | 3.5 | 3.4 | 3.1 | 3.3 | 3.4 | 3.6 | 3.6 | 3.7 | 3.7 | 3.8 | 3.8 | 3.8 | 3.9 | 4.0 |
| 5 | 4.2 | 3.4 | 3.3 | 3.2 | 3.2 | 3.5 | 3.5 | 3.5 | 3.6 | 3.8 | 3.8 | 3.7 | 3.8 | 3.9 | 4.1 |
| 6 | 4.1 | 3.4 | 3.2 | 3.2 | 3.3 | 3.4 | 3.4 | 3.6 | 3.6 | 3.7 | 3.7 | 3.7 | 3.7 | 3.9 | 4.2 |
| 7 | 4.2 | 3.5 | 3.3 | 3.1 | 3.2 | 3.6 | 3.5 | 3.7 | 3.7 | 3.7 | 3.7 | 3.8 | 3.8 | 3.8 | 4.2 |
| 8 | 4.1 | 3.4 | 3.4 | 3.1 | 3.3 | 3.4 | 3.6 | 3.6 | 3.6 | 3.8 | 3.7 | 3.7 | 3.9 | 3.9 | 4.1 |
| 9 | 4.2 | 3.5 | 3.2 | 3.2 | 3.3 | 3.3 | 3.5 | 3.5 | 3.8 | 3.7 | 3.8 | 3.8 | 3.9 | 3.9 | 4.1 |
| 10 | 4.2 | 3.6 | 3.3 | 3.1 | 3.1 | 3.4 | 3.5 | 3.6 | 3.6 | 3.7 | 3.7 | 3.7 | 3.8 | 3.8 | 4.1 |
| Average | 4.16 | 3.45 | 3.29 | 3.13 | 3.24 | 3.42 | 3.52 | 3.60 | 3.64 | 3.71 | 3.75 | 3.76 | 3.82 | 3.86 | 4.13 |
| value | | | | | | | | | | | | | | | |

As can be seen from the data in Table 10, when the thickness of the conductive anticorrosion layer is greater than 3000 μm and less than 0.3 μm, the voltage drop of the plugged structure of the plug-in terminal 11, the grounding terminal 21 and the mating terminal 23 is greater than 4 mV, which does not meet the requirement. Therefore, the inventor selects the thickness of the conductive anticorrosion layer to be 0.3 μm to 3000 μm. In which, when the thickness of the conductive anticorrosion layer is in the range of 2.5 μm to 1000 μm, the voltage drop of the plugged structure of the plug-in terminal 11, the grounding terminal 21 and the mating terminal is an optimal value, so the inventor exemplarily selects the thickness of the conductive anticorrosion layer to be 2.5 μm to 1000 μm.

In an embodiment, the material of the conductive anticorrosion layer includes one or more of nickel, cadmium, manganese, zirconium, cobalt, tin, titanium, chromium, gold, silver, zinc, tin-lead alloy, silver-antimony alloy, palladium, palladium-nickel alloy, graphite silver, graphene silver, hard silver and silver-gold-zirconium alloy.

Exemplarily, the potential of the material of the conductive anticorrosion layer is between the potential of the materials of the plug-in terminal 11 and the grounding terminal 21 and the potential of the material of the mating terminal. This solution can reduce the electrochemical corrosion generated after the plug-in terminal 11 and the grounding terminal 21 are plugged with the mating terminal.

Next, taking the plug-in terminal 11 and the grounding terminal 21 as an example, the plug-in terminal 11 and the grounding terminal 21 are provided with the conductive anticorrosion layers. In order to verify the influence of different the conductive anticorrosion materials on the performances of the plug-in terminal 11 and the grounding terminal 21, the inventor adopts the same specification and material, and utilizes the plug-in terminal 11 and the grounding terminal 21 of different conductive anticorrosion materials to carry out a series of tests on the corrosion resistance time, and the test results are shown in Table 11.

The test on the corrosion resistance time in Table 11 is to put the samples of the plug-in terminal 11 and the grounding terminal 21 into a salt spray test chamber, spray salt fog for each position on the plug-in terminal 11 and the grounding terminal, take out and clean the samples every 20 hours to observe the surface corrosions thereof, which is a cycle, stop the test when a corrosion area of the surface of each of the samples of the plug-in terminal 11 and the grounding terminal 21 is more than 10% of a total area thereof, and then record the number of cycles at that time. In this embodiment, the number of cycles less than 80 is unqualified.

TABLE 11
Influence of different materials of the conductive anticorrosion layer on the corrosion
resistance of the samples of the plug-in terminal 11 and the grounding terminal 21
Different materials of the conductive anticorrosion layer

| | | | | | | | | |
|---|---|---|---|---|---|---|---|---|
| Nickel | Cadmium | Manganese | Zirconium | Cobalt | Tin | Titanium | Zinc | Chrome |

Number of cycles of corrosion resistance tests

| | | | | | | | | |
|---|---|---|---|---|---|---|---|---|
| 88 | 128 | 121 | 129 | 128 | 85 | 122 | 85 | 109 |

Different materials of the conductive anticorrosion layer

| | | | | | | | | | |
|---|---|---|---|---|---|---|---|---|---|
| | | | | | Silver- | | | | |
| | | Silver- | | | gold- | | | | |
| | | antimony | Graphite | Graphene | zirconium | | Palladium- | Tin-lead | Hard |
| Gold | Silver | alloy | silver | silver | alloy | Palladium | nickel alloy | alloy | silver |

Number of cycles of corrosion resistance tests

| | | | | | | | | | |
|---|---|---|---|---|---|---|---|---|---|
| 135 | 129 | 124 | 136 | 127 | 134 | 113 | 123 | 115 | 138 |

As can be seen from Table 11, when the material of the conductive anticorrosion layer includes conventional metals such as tin, nickel and zinc, the test results are not as good as those of other metals, because the test results of other metals far exceed the standard values, and the performances are stable. Therefore, the inventor selects that the material of the conductive anticorrosion layer includes (or is) one or more of nickel, cadmium, manganese, zirconium, cobalt, tin titanium, chromium, gold, silver, zinc-tin-lead alloy, silver-antimony alloy, palladium, palladium-nickel alloy, graphite silver, graphene silver, hard silver and silver-gold-zirconium alloy. More exemplarily, the material of the conductive anticorrosion layer includes (or is) one or more of cadmium, manganese, zirconium, cobalt, titanium, chromium, gold, silver, tin-lead alloy, silver-antimony alloy, palladium, palladium-nickel alloy, graphite silver, graphene silver, hard silver and silver-gold-zirconium alloy.

In an embodiment, the conductive part of the protective conductor 20 is integrally formed with the grounding terminal 21. The conductive part of the protective conductor 20 and the grounding terminal 21 may be made of the same material, that is, the conductive part of the protective conductor 20 is extended and molded as the grounding terminal 21, thereby saving the use of the grounding terminal 21, reducing the material cost and the processing time, and molding the front end of the conductive part of the protective conductor 20 into various shapes as required, without considering the assembly problem.

In an embodiment, the conductive part of the functional cable 10 is integrally formed with the plug-in terminal 11. The conductive part of the functional cable 10 and the plug-in terminal 11 may be made of the same material, that is, the conductive part of the functional cable 10 is extended and molded as the plug-in terminal 11, thereby saving the use of the plug-in terminal 11, reducing the material cost and the processing time, and molding the front end of the conductive part of the functional cable 10 into various shapes as required, without considering the assembly problem.

The present disclosure further discloses an electric energy transmission apparatus, which includes the connection mechanism having a shield.

The present disclosure further discloses a motor vehicle, which includes the connection mechanism having a shield and the electric energy transmission apparatus.

The connection mechanism having a shield in the present disclosure is provided with an inner shell which is integrally injection-molded with the functional cable and the plug-in terminal, so that the processing is simple, and the cost is much lower than that of a shielding metal shell. Through a plug-in cooperation between the connection mechanism having a shield and a mating connection mechanism, as well as the electrical connection with the shielding net of the functional cable and the protective conductor, it is possible to effectively shield the electromagnetic interference in the connection mechanism, and reduce the electromagnetic interference on other devices.

The protective shielding shell in the present disclosure is connected to the shielding net of the functional cable in various ways, so that the protective shielding shell can be stably and effectively connected to the shielding net, thereby achieving a better shielding effect.

The protective shielding shell in the present disclosure is electrically connected to not only the shielding net of the functional cable, but also the protective conductor or the grounding terminal to ensure double grounding. Even if the shielding net of the functional cable fails to be grounded, it may be grounded through the protective conductor, so that the shielding current can be smoothly led out and the interference of the electromagnetic shielding can be reduced.

The embedded high-voltage interlocking structure replaces the traditional assembled high-voltage interlocking structure, and is fixed in the connection mechanism by integral injection-molding without assembling, so that the cost is reduced and the high-voltage interlocking effect is completely satisfied.

The seal structure of the connection mechanism is no longer a separate seal ring, but adopts a secondarily injection-molded seal structure to replace the traditional seal ring, so as to be directly molded on the connection mechanism, thereby achieving a better injection bonding and a lower cost.

By adopting the temperature measuring structure, it is possible to separately monitor the terminal temperature inside the connection mechanism, and avoid the situation that the temperature of the connection mechanism cannot be monitored due to the damage of the temperature sensors in other positions.

Those described above are only a few embodiments of the present disclosure, and those skilled in the art can make various modifications or variations to the embodiments of the present disclosure according to the disclosure of the application document without departing from the spirit and scope of the present disclosure.

1. A connection mechanism having a shield, comprising a functional cable, a plug-in terminal, an inner shell integrally formed with the functional cable and the plug-in terminal, and a protective shielding shell disposed on at least part of an outer periphery of the inner shell; the functional cable is provided with a shielding layer, to which the protective shielding shell is at least partially electrically connected.

2. The connection mechanism having a shield according to claim 1, further comprising a protective conductor and a grounding terminal, one end of the protective shielding shell is at least partially electrically connected to the shielding layer, and the other end thereof is at least partially electrically connected to the protective conductor or the grounding terminal.

3. The connection mechanism having a shield according to claim 1, wherein the protective shielding shell comprises a shielding device which is at least partially electrically connected to the shielding layer.

4. The connection mechanism having a shield according to claim 1, wherein an inner surface of the protective shielding shell is further provided with an electrically-conductive elastic sheet, which is in contacted connection with the shielding layer and applies a pressure to the shielding layer.

5. The connection mechanism having a shield according to claim 4, wherein the pressure applied by the electrically-conductive elastic sheet is in a range of 0.3 N to 95 N.

6. The connection mechanism having a shield according to claim 1, wherein an impedance between the protective shielding shell and the shielding layer is less than 80 mΩ.

7. The connection mechanism having a shield according to claim 1, wherein a transfer impedance of the protective shielding shell is less than 100 mΩ.

8. The connection mechanism having shield according to claim 1, wherein the protective shielding shell and at least part of the shielding layer are integrally injection-molded.

9. The connection mechanism having a shield according to claim 1, wherein the plug-in terminal comprises a first fixation portion and a plug-in portion which are sequentially disposed.

10. The connection mechanism having a shield according to claim 9, wherein the functional cable comprises a cable core disposed at an innermost part of the functional cable, the shielding layer sleeved around an outer periphery of the cable core, and an insulation layer sleeved around an outer periphery of the shielding layer, and the first fixation portion is electrically connected to a conductive part of the cable core.

11. The connection mechanism having a shield according to claim 9, wherein the plug-in portion is columnar and at least partially protrudes from the inner shell, or the inner shell has a groove, and the plug-in portion at least partially protrudes from a bottom surface of the groove without exceeding the inner shell.

12. The connection mechanism having a shield according to claim 9, wherein the plug-in portion is barrel-shaped and at least partially protrudes from an outer wall of the inner shell, or the inner shell is provided with an open boss in which the plug-in portion is at least partially disposed.

13. The connection mechanism having a shield according to claim 9, wherein the protective shielding shell at least wraps the first fixation portion and at least part of the functional cable, but is insulated from the plug-in terminal and a conductive part of the functional cable.

14. The connection mechanism having a shield according to claim 9, wherein the inner shell is integrally injection-molded on outer peripheries of at least the first fixation portion, the plug-in terminal and a conductive part of the functional cable, and achieves an insulation effect.

15. The connection mechanism having a shield according to claim 1, wherein the protective shielding shell at least wraps the outer periphery of the inner shell, and the protective shielding shell is integrally injection-molded on at least part of the outer periphery of the inner shell.

16. The connection mechanism having a shield according to claim 1, wherein the outer periphery of the inner shell and/or the protective shielding shell is further integrally injection-molded with an outer insulation shell, which wraps at least part of the inner shell and/or the protective shielding shell and at least part of the functional cable.

17. The connection mechanism having a shield according to claim 1, further comprising an interlocking connection mechanism at least partially integrally injection-molded in the inner shell.

18. The connection mechanism having a shield according to claim 2, wherein the grounding terminal comprises a second fixation portion and a plug-in portion, and the second fixation portion is electrically connected to the protective conductor.

19-31. (canceled)

32. An electric energy transmission apparatus, comprising the connection mechanism having a shield according to claim 1.

33. A motor vehicle, comprising the connection mechanism having a shield according to claim 1.
